(19) United States
(12) Patent Application Publication
(10) Pub. No.: US 2026/0365166 A1
(43) Pub. Date: Nov. 19, 2026

(54) Device and Method for Determining a Suitable Reference Speed for at Least One Driver Assistance System of a Vehicle

(71) Applicant: BAYERISCHE MOTOREN WERKE AKTIENGESELLSCHAFT, Muenchen (DE)

(72) Inventor: Martin MILLER, Muenchen (DE)

(21) Appl. No.: 19/515,857

(22) PCT Filed: Aug. 5, 2024
(86) PCT No.: PCT/EP2024/072119

§ 371 Date: Mar. 3, 2026

(30) Foreign Application Priority Data
Sep. 5, 2023 (DE) 10 2023 123 873.6

(51) Int. Cl. B60W 30/16; B60W 50/00

(52) U.S. Cl. CPC B60W 30/16; B60W 50/0098; B60W 2050/0022; B60W 2520/06; B60W 2530/201; B60W 2552/05; B60W 2552/10; B60W 2554/20; B60W 2554/4026; B60W 2554/4029; B60W 2554/4044; B60W 2554/801; B60W 2554/802; B60W 2554/804; B60W 2555/20; B60W 2720/10; B60W 2754/30; B60W 2754/50

(57) ABSTRACT

A device and a method for determining a suitable reference speed for at least one driver assistance system of a vehicle is disclosed. The device includes at least one surroundings detection unit configured to record, in a current driving section, at least one item of surroundings information related to surroundings of the vehicle (e.g., a region ahead of the vehicle in a direction of travel of the vehicle). The device may also generate and process surroundings data corresponding to the surroundings information are generated and may ascertain a suitable reference speed for the current driving section based on the surroundings data.

### BACKGROUND AND SUMMARY

The present disclosure relates to a device and a method for determining a suitable reference speed for at least one driver assistance system of a vehicle. In a current driving section, at least one item of surroundings information relating to the surroundings of the vehicle is detected with the aid of at least one surroundings detection unit, at least over a region in front of the vehicle in the direction of travel of the vehicle, and surroundings data corresponding to the surroundings information are generated.

Driver assistance systems are known under the designation ISA for assisting the driver in maintaining the current speed limit on the road section being traveled on. ISA is an abbreviation for Intelligent Speed Adaption/Intelligent Speed Adaptation or Intelligent Speed Assistance. Vehicle drivers are alerted via vehicle feedback when they exceed the maximum allowed speed. Faster driving is still possible, for example in order to avoid oncoming traffic in good time when passing. ISA may be overridden or completely shut down for this purpose. The ISA technology also does not provide for automatic actuation of the brake.

The speed limit determined by the ISA driver assistance system can then also be used as a setpoint value for a further driver assistance system, for example an ACC—Adaptive Cruise Control, which is also referred to as automatic distance regulation (ADR). In the ACC driver assistance system, a vehicle driving ahead is detected and its speed is determined. Through targeted automatic braking and engine interventions, a desired distance from the vehicle driving ahead is maintained. ACC builds on the vehicle speed control (cruise control). Unlike a simple cruise control, ACC automatically brakes when the ego vehicle is faster than a vehicle traveling in front, and keeps a distance set by the vehicle driver.

In ACC driver assistance systems, a radar sensor and/or a lidar sensor and/or a camera is often used as the environmental sensor. With the aid of the environmental sensor, the ACC driver assistance system monitors the area in front of the vehicle. For this purpose, the environmental sensor emits electromagnetic pulses. If they strike a solid obstacle, they are reflected and received again. From the received signals, it is possible to calculate, via a transit time measurement, in which direction, at which distance and at which relative speed vehicles ahead are moving.

Document DE 10 2022 102 000 A1 discloses a method for detecting objects in the surroundings of a vehicle, comprising the following steps:
receiving detection data and object data from at least one environment sensor,
identifying relevant static objects and dynamic objects in the object data based on at least one predetermined assignment criterion,
Assigning the detection data to the object data identified as relevant static objects and as dynamic objects, assigning the detection data not assigned to the relevant static objects and the dynamic objects to a static object list, wherein the static object list describes static objects in the surroundings,
Assigning the relevant static objects and the dynamic objects to a dynamic object list, the dynamic object list describing potential dynamic objects in the surroundings.

The static objects can be further divided into the relevant static objects and the non-relevant static objects. The relevant static objects describe in particular those objects to which a reaction has to take place with the driver assistance system. The reaction can be understood as an adjustment of the longitudinal speed, for example a braking intervention. These relevant static objects can for the most part be located in a driving envelope or driving lane of the ego vehicle. Further, the external shape of the relevant static objects can be estimated. For example, a so-called bounding box can be assigned to these relevant static objects. The relevant static objects can be, in particular, other road users. The relevant static objects can be currently or briefly stationary but can move again in the future.

The non-relevant static objects may be obstacles, for example. The non-relevant static objects can partially project into the driving envelope or driving lane of the ego vehicle. For example, a lost load or a parked vehicle that partially protrudes into the lane may represent a non-relevant static object. A possible reaction to a non-relevant static object can be an avoidance maneuver, for example, by the driver assistance system. In addition, non-relevant static objects often cannot be sufficiently well described by a bounding box.

The reference speed of current driver assistance systems, such as ISA and speed limiters (limiters), currently corresponds to the permissible maximum speed for the current driving section on a straight road. However, this speed is not always the optimum speed from a safety point of view. On a narrow road with many parked vehicles, a human driver of the vehicle will generally voluntarily reduce its speed, in order to be able to brake in good time, for example in the event of crossing pedestrians. Currently, there is as yet no technical system that calculates a corresponding speed that corresponds to an appropriate speed for the current traffic situation.

It is an object of the present disclosure to specify a device and a method for determining a suitable reference speed for at least one driver assistance system of a vehicle.

This object is achieved by a device having the features disclosed herein and/or by a method having the features disclosed herein. Advantageous further developments are also specified herein.

The device achieves the result that a suitable reference speed for the current driving section, which reference speed is dependent on the surroundings, in particular on the current traffic situation, is easily determined. This reference speed can then be used for an ISA driver assistance system, a speed limiting system (limiter), an ACC driver assistance system or a semi-autonomous or autonomous vehicle. The determination of the suitable reference speed is not the determination of the permissible maximum speed for the current driving section and takes place in particular independently of the permissible maximum speed applicable for the current driving section. The permissible maximum speed, optionally plus an offset, can, however, serve as an upper limit or as an initial value for a correction value or correction factor. By determining the suitable reference speed, the vehicle driver is given a safe driving feel. Faulty reactions of the vehicle driver are avoided and driving safety is increased.

The embodiments disclosed herein may be used for the determination or the calculation of a dynamic reference speed for the ISA driver assistance system and the speed limiting system based on the current traffic situation. This dynamic reference speed corresponds to a suitable reference speed. This dynamic reference speed can be limited by a lower limit v_min and an upper limit v_max. v_max results from the permissible maximum speed for the current driving section, optionally+/− an offset set by the vehicle driver. v_min is an applicable value which corresponds to a minimum speed still acceptable for the vehicle driver. At a permissible maximum speed of 50 km/h, for example v_min=20 km/h is conceivable. The dynamic reference speed is obtained by a traffic situation-dependent factor which generates values between v_min and v_max. The traffic situation-dependent factor results from the consideration of environmental factors which are reduced to a factor value by an appropriate method (e.g. weighted average).

Possible environmental factors are:
the width of the driving envelope, in particular distance between parked vehicles and vehicles driving in the opposite lane (the narrower, the lower speed)
the relative number of parked vehicles which obscure the view of, for example, persons (the more parked vehicles, the lower the speed)
the number of lanes in the direction of travel of the vehicle (the more lanes, the higher the speed)
the amount of built structures: in residential areas, persons who might be running into the road are more likely than in industrial areas or roads without buildings
the average speed driven by other vehicles on the current road section (learned from inventory fleet, stored in map)
brightness: day or night, good or poor road lighting (the poorer visibility, the lower the speed).

Additional or alternative environmental factors are given below.

It is advantageous if the region in front of the vehicle detected with the aid of the surroundings detection unit is part of the current driving section. Alternatively or additionally, the current driving section can be part of the region in front of the vehicle detected with the aid of the surroundings detection unit. As a result, the processing unit can ascertain information relevant to the traffic situation in the current driving section based on the surroundings data.

The current driving section can be, in particular, the route from the vehicle to the next traffic network node in the direction of travel, in particular to the next intersection and/or branching point. The region in front of the vehicle detected with the aid of the surroundings detection unit can be smaller, in particular shorter in the direction of travel, than the current driving section. In addition, in particular in the region in front of a traffic network node, the current driving section can be smaller, in particular shorter in the direction of travel, than the region in front of the vehicle detected with the aid of the surroundings detection unit.

Furthermore, the processing unit can be designed to preset the determined suitable reference speed and then use it as the maximum speed of the vehicle for the current driving section if this is less than the permissible maximum speed. This determined reference speed can thereby be provided or predefined as a reference value to a further assistance system, such as an ACC and/or an ISA driver assistance system.

The processing unit can also be designed to determine the traffic space available for the vehicle based on the surroundings data and determine the suitable reference speed.

Furthermore, the processing unit can be designed to determine the driving envelope available for the vehicle in the current driving section in a first processing step for determining the available traffic space, and in a second step to perform an evaluation of the driving envelope and to determine the suitable reference speed based on the evaluation of the driving envelope. In this way, a suitable reference speed can be determined in a simple manner. Alternatively or additionally, preset preferences for the vehicle and/or for the vehicle driver, such as particularly slow driving at a small lateral distance from vehicles to be parked, passing and/or oncoming vehicles, can be stored in a preset manner.

Alternatively or additionally, in a database assigned to the vehicle and/or the vehicle driver, the speed actually driven in the current driving section by the vehicle driver and/or the vehicle during a preceding drive in an identical or similar traffic situation can be determined and determined as a suitable reference speed and/or, starting from the speed actually driven in the current driving section during a preceding drive in another traffic situation, the suitable reference speed can be determined taking into account the deviations of the current and the other traffic situation. Speeds of identical or similar vehicles on the current driving section stored in a database, so-called fleet data, can also be used alternatively or additionally to the speed of the driver in front to determine the suitable reference speed.

It is particularly advantageous if the processing unit is designed to take account of the traffic situation in the current driving section, in particular at least one of the following environmental factors, based on the surroundings data for evaluating the ascertained driving path, wherein the driving lane in which the vehicle is located is a driving lane of a road:
the width of the driving lane in which the vehicle is located,
the width of the vehicle,
the number of driving lanes in the direction of travel of the vehicle and/or in the opposite direction,
the presence of a stationary vehicle on the right-hand side of the road,
the presence of a stationary vehicle on the left-hand side of the road,
the distance between a plurality of vehicles parked one behind the other on the right-hand side of the road,
the distance between a plurality of vehicles parked one behind the other on the left-hand side of the road,
a person in the driving lane,
the presence of a footpath and/or cycle path adjacent to the driving lane,
the presence of a person and/or a vehicle on a footpath and/or cycle path adjoining the lane,
classifying the road as a road inside a closed area or outside a closed area,
classifying the road as an expressway, secondary road, and/or residential street,
classifying the road as a road in a residential area or a commercial area or a non-built-up area,
width of the lane of the opposite direction of travel adjoining the lane on which the vehicle is located,
the presence of an oncoming vehicle,
width of an oncoming vehicle,
possible and/or probable lateral distance from an oncoming vehicle when driving past one another,
possible and/or probable lateral distance from a parked vehicle when driving past it,
obstacle present on the lane of the vehicle or on a lane adjoining the lane,
lateral narrowing of the roadway, in particular for traffic calming,
currently existing vision,
brightness of the surroundings and/or illumination of the road,
time of day.

A speed value increasing or reducing the reference speed or a factor increasing or reducing the reference speed can also be preset for each environmental factor to be taken into account and/or for each group of environmental factors to be taken into account, wherein when determining a plurality of speed values increasing or reducing the reference speed, a weighted average value is preferably determined which is then taken into account when determining the reference speed to be preset, and/or wherein when determining a plurality of factors increasing or reducing the reference speed, a weighted average value is preferably determined which is then taken into account when determining the reference speed to be preset.

In general, at least one reference speed suitable for the vehicle in the current driving section can also be stored in a database arranged in the vehicle or in a database of the device arranged outside the vehicle, which reference speed can be determined as a reference speed to be preset, wherein a plurality of reference speeds suitable for the vehicle in the current driving section are preferably stored in the database, wherein at least one of the environmental factors specified further above is assigned to each reference speed.

It is furthermore advantageous if the processing unit is designed to determine the reference speed to be preset in such a way that it does not exceed a preset upper speed limit value and does not fall below a preset lower limit value. The preset limit values may be dependent on a maximum speed permissible in the current driving section. In particular, the upper limit value can be the maximum speed permissible in the current driving section, in particular plus a preset offset that is set by or for the vehicle driver.

The method has the same advantages as the device. In particular, the method can be further developed with the features of the device and the previously mentioned developments.

Exemplary embodiments are explained in more detail below with reference to the figures. In the figures:

### BRIEF DESCRIPTION OF THE DRAWINGS

FIG. 1 shows a perspective schematic illustration of a cockpit of a vehicle; and

FIG. 2 shows a schematic plan view of a first traffic situation; and

FIG. 3 shows a schematic plan view of a second traffic situation.

### DETAILED DESCRIPTION OF THE DRAWINGS

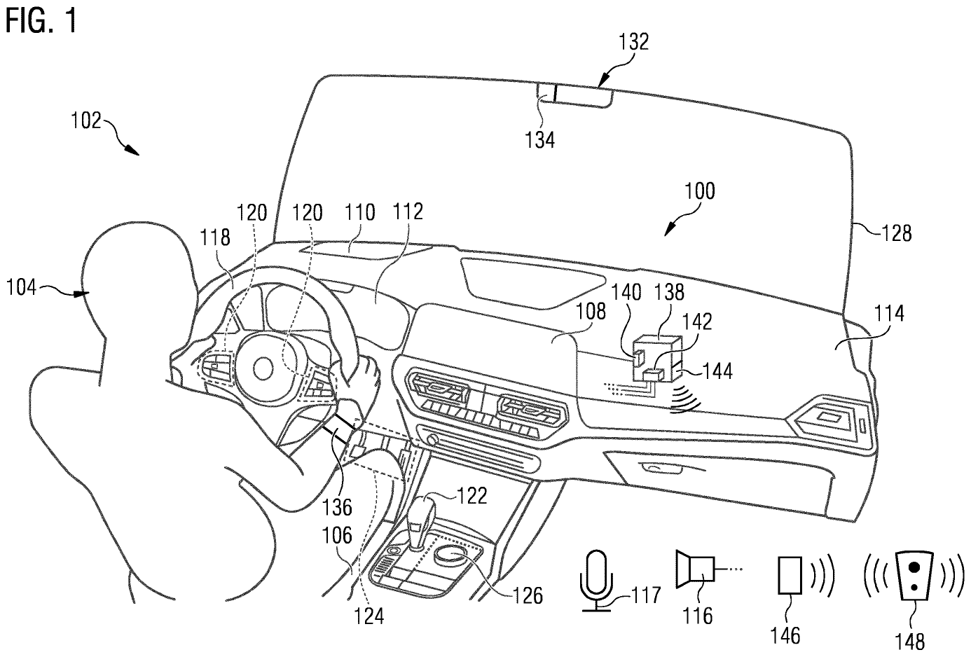

FIG. 1 shows a perspective schematic illustration of a cockpit 100 of a vehicle 102. A vehicle driver 104 sits on a driver's seat 106 of the vehicle 102. The cockpit 100 also comprises a central information display (CID) 108, a head-up display 110 and a graphical instrument cluster 112, which are arranged in an instrument panel 114 of the vehicle 102. The aforementioned display elements 108, 110, 112 each form a functional unit of an output unit of the vehicle 102, which is designed to output information to the vehicle driver 104. At least one loudspeaker 116 and one microphone 117 of the vehicle 102 are likewise arranged in the cockpit 100. The loudspeaker 116 constitutes a functional unit of the output unit, and the microphone 117 constitutes a functional unit of the input unit. The functional units of the output unit and of the input unit also serve as a playback unit for audio and/or video playback.

The cockpit 100 further comprises a steering wheel 118 with operating elements 120, a gear selector 122, a pedal mechanism 124, and an input unit 126 with a rotary wheel and a pushbutton function and/or a touch input panel. This input unit 126 is also referred to as an Ergo Commander.

In the upper region of a front windshield 128 of the vehicle 102, an interior rear-view mirror 132 and a front camera 134 mounted on the front windshield in the region of this interior rear-view mirror 132 are arranged. The camera 134 is designed to capture images with an image of at least one region of a current driving section of the vehicle 102. In other words, the front camera 134 captures at least one item of surroundings information related to the surroundings of the vehicle 102, at least over a region in front of the vehicle 102 in the direction of travel of the vehicle 102. The front camera 134 may be a mono camera or a stereo camera, preferably an IR-RGB camera.

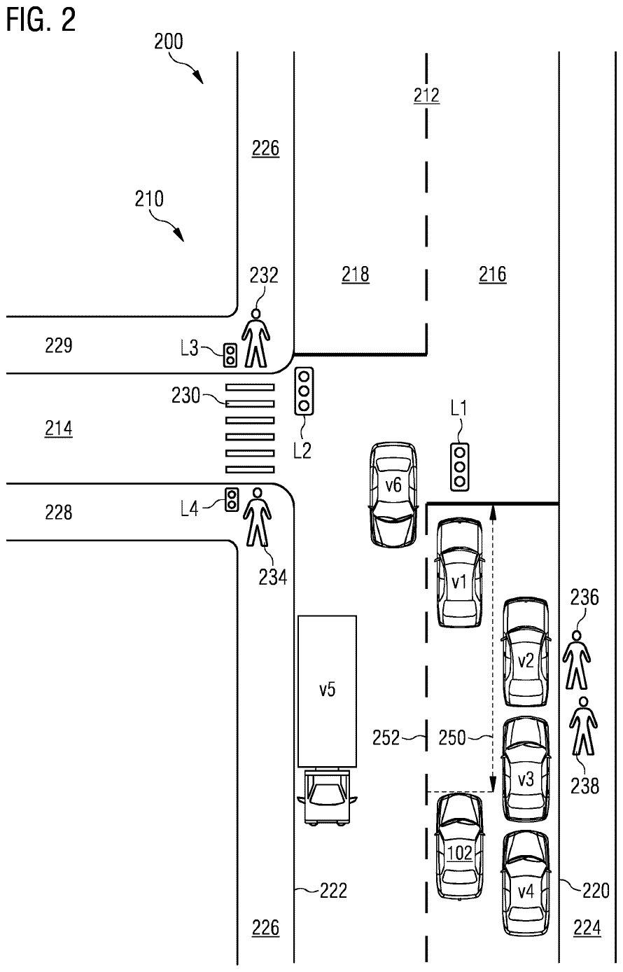

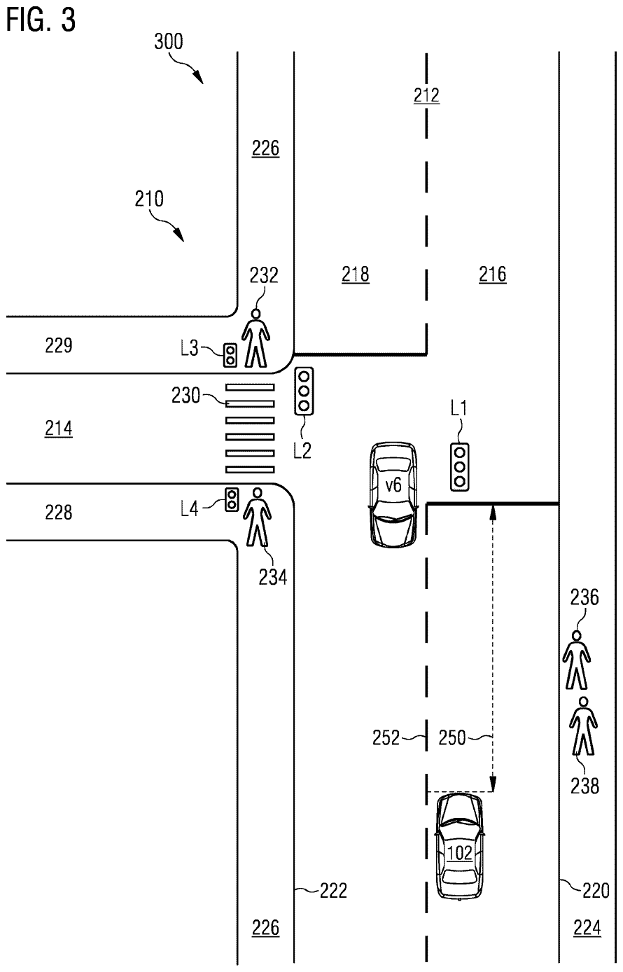

A plan view 200 of a traffic situation, from which the camera 134 captures an image from the perspective of the vehicle 102 or of the vehicle driver 104, is shown in FIGS. 2 and 3. The camera 134 is in particular designed to capture a plurality of temporally consecutive images, in particular in the form of a video stream, to generate image data corresponding to the images and to transmit said image data to a control unit 138 serving as a processing unit.

The control unit 138 has data outputs 140 and data inputs 142 which are used for connection to further units of the vehicle 102, for example to further cameras, sensors, input and output units and control units of assistance systems. Thus, the vehicle 102 has at least one control unit for providing an ACC (Adaptive Cruise Control) driver assistance system and an ISA (Intelligent Speed Assistance System) driver assistance system. The ISA driver assistance system is used to assist the vehicle driver 104 in maintaining the current speed limit on the road section currently being driven on.

The speed limit determined by the ISA driver assistance system can then also be used as a reference value for the ACC driver assistance system. The ACC driver assistance system recognizes a vehicle traveling ahead using a surroundings detection unit (front camera, lidar sensor and/or radar sensor) and ascertains its speed. By automatic braking and engine interventions, the ACC driver assistance system maintains a desired distance.

The control unit 138 further comprises a communication module 144 which is designed to establish a connection to a telecommunication network, in particular a mobile radio network. Via this communication module 144, in particular car-to-car communication and infrastructure-to-car communication are easily possible.

FIG. 2 shows a schematic plan view of a first traffic situation 200 with the vehicle 102. Identical elements or elements with the same structure or the same function have the same reference signs. In plan view, a traffic network node 210 is shown, which comprises a two-lane road 212 and a single-lane road 214. The two-lane road 212 includes a first directional lane 216 and an opposite directional lane 218 (opposite lane). The single-lane road 212 is a side road 220 branching off from the two-lane road 212 at the traffic node 210. There is a traffic light system at traffic network node 210 with light signals L1 for the first directional lane 216, L2 for the second directional lane 218, and L3 and L4 for a crossing region 230 for pedestrians 232, 234.

The vehicle 102 (ego vehicle) is located on the first directional lane 216, and the vehicle v1 is located in front of vehicle 102. A combined footpath and cycle path 224 adjoins the right-hand edge of the roadway 220 of the road 212 and a second combined footpath and cycle path 224 adjoins the left-hand edge of the roadway 222 of the road 212. Similarly, combined footpath and cycle paths 228, 229 are adjacent to the road edges of the road 214.

The distance between the vehicle 102 and the traffic node 210 is the length of the current road section 250 of the vehicle 102. The surroundings detection unit comprising the camera 134, the lidar sensor 148 and/or the radar sensor 146 detects all road users (vehicles and persons), to the extent they are detectable, in order to detect the illustrated traffic situation 200 as completely as possible, but at least in the region of the driving lane 216 and the oncoming driving lane 218 in the current driving section 250.

Two pedestrians 236, 238 are located on the combined footpath and cycle path 224. Parked vehicles v2, v3, v4 are located on the right-hand side of the roadway 220 in front of and next to the vehicle 102. On the opposite roadway 218, a parked truck v5 is located on the side of the road 222, which due to its width makes it difficult for oncoming vehicles v6 arriving to pass through, since these vehicles must drive up to the separating line 252 between the directional lanes 216, 218 or beyond the latter onto the opposite roadway 216 in order to pass the parked truck v5. When the truck v5 is passed by the vehicle v6 and the continued travel of the vehicle 102 simultaneously, the expected lateral distance of the vehicle 102 from the oncoming vehicle v6 and from the parked vehicles v2 and v3 is small, and therefore the maximum speed of, for example, 50 km/h which is permissible on this current travel section is not a speed which is appropriate for the traffic situation. The control unit 138 then determines a suitable reference speed based on the surroundings data of the surroundings detection unit 134, 146, 148 and/or determined environmental factors. This suitable reference speed is thus a speed adapted to the traffic situation and is specified as a reference value in particular to a further driver assistance system, for example the ACC and/or ISA of the vehicle 102.

Based on the traffic situation shown in FIG. 2, in particular based on the short distance from the parked vehicles v2 and v3 and the expected short distance from the oncoming vehicle v6, the control unit 138 determines a suitable reference speed of 40 km/h for the current driving section 250.

Alternatively or additionally, in a database assigned to the vehicle 102 and/or the vehicle driver 104, the speed actually traveled by the vehicle driver 104 and/or the vehicle 102 during a previous journey in an identical or similar traffic situation in the current driving section 250 may be ascertained and determined as a suitable reference speed by the control unit 138. Speeds of identical or similar vehicles 102 stored in a database, so-called fleet data, on the current driving section 250 can also be used alternatively or in additional to the speed of the preceding journey for ascertaining the suitable reference speed.

To take into account the traffic situation 200 when determining the suitable reference speed for the current driving section 250, the control unit 138 takes into account at least one or more of the following environmental factors:
the width of the driving lane 216 on which the vehicle 102 is located,
the width of the vehicle 102,
the number of driving lanes 216 in the direction of travel P of the vehicle 102 and/or in the opposite direction,
the presence of a stationary vehicle v2 to v4 on the right-hand side of the road 220,
the presence of a stationary vehicle v5 on the left-hand side of the road 222,
the distance between a plurality of vehicles v2 to v4 parked one behind the other on the right-hand side of the road,
the distance between a plurality of vehicles v5 parked one behind the other on the left-hand side of the road 222,
a person in the driving lane 216,
the presence of a footpath and/or cycle path 224 adjoining the driving lane 216,
the presence of a person 236, 238 and/or a vehicle in a footpath and/or cycle path 224 adjoining the driving lane 216,
classification of the road 212 as a road within a closed area or outside a closed area,
classification of the road 212 as an expressway, secondary road 216 and/or residential street 214,
classification of the road 216 as a road in a residential area or a commercial area or a non-built up area,
width of the driving lane 218 of the opposite direction of travel P adjacent to the lane 216 on which the vehicle 102 is located,
the presence of an oncoming vehicle v6,
width of an oncoming vehicle v6,
possible and/or probable lateral distance from an oncoming vehicle v6 when driving past one another,
possible and/or probable lateral distance from a parked vehicle v2, v3, v4, v5 when driving past,
obstacle present on the lane 216 of the vehicle 102 or on a lane 218 adjacent to the lane 216,
lateral narrowing of the driving lane 216, 218, in particular for traffic calming,
currently existing vision,
brightness of the surroundings and/or illumination of the road 212,
time of day.

The control unit 138 may preset a speed value increasing or reducing the reference speed or a factor increasing or reducing the reference speed for each environmental factor to be considered and/or for each group of environmental factors to be considered. In particular, when ascertaining a plurality of speed values increasing or reducing the reference speed or a plurality of factors increasing or reducing the reference speed, a weighted average value can be formed, which is then taken into account in determining the suitable reference speed.

The determination of a suitable reference speed is thus carried out by calculating a dynamic reference speed for the ISA driver assistance system and the speed limiting system, which reference speed is also variable in the same driving section 250, based on the ascertained current traffic situation, in particular of the traffic space available for the vehicle 102 in the current driving section 250. This dynamic reference speed can be limited by a lower limit v_min and an upper limit v_max. v_max results from the permissible maximum speed for the current driving section 250, optionally+/− an offset set by the vehicle driver 104. v_min is an applicable value which corresponds to a minimum speed still acceptable for the vehicle driver 104. At a permissible maximum speed of 50 km/h, for example, v_min=20 km/h is conceivable. The dynamic reference speed is obtained by a traffic situation-dependent factor which generates values between v_min and v_max. The traffic situation-dependent factor results from the consideration of environmental factors which are reduced to a factor value by an appropriate method (e.g. weighted average).

FIG. 3 shows a schematic plan view of a first traffic situation 300 with the vehicle 102, similar to the traffic situation 200 according to FIG. 2 at the same traffic network node 210. Identical elements or elements with the same structure or the same function have the same reference signs. In contrast to the traffic situation 200 according to FIG. 2, the vehicles v1 to v5 are not present in the traffic situation 300. As a result, the control unit 138 uses the surroundings data to determine a traffic situation 300 in the current driving section 250 which does not require a reduction in the permissible maximum speed, so that the suitable reference speed then corresponds to the permissible maximum speed or to a speed predefined by the vehicle driver.

| | |
|---|---|
| 100 | cockpit |
| 102 | vehicle |
| 104 | vehicle driver |
| 106 | driver's seat |
| 108 | central information display |
| 110 | head-up display |
| 112 | graphical instrument cluster |
| 114 | instrument panel |
| 116 | loudspeaker |
| 117 | microphone |
| 118 | steering wheel |
| 120 | operating element |
| 122 | gear selector |
| 124 | pedal mechanism |
| 126 | input unit |
| 128 | front windshield |
| 132 | inside rear-view mirror |
| 134 | front camera |
| 138 | control unit |
| 140 | data output |
| 142 | data input |
| 144 | communication module |
| 146 | radar sensor |
| 148 | lidar sensor |
| 200 | first traffic situation |
| 210 | traffic network node |
| 212, 214 | road |
| 216, 218 | directional lane/driving lane |
| 220, 222 | roadside |
| 224, 226, | |
| 228, 229 | footpath and cycle path |
| 230 | crossing region |
| 232 to 238 | pedestrians |
| 250 | current driving section |
| 252 | separating line |
| V1 to v6 | vehicles |
| L1 to L4 | traffic light system |
| P | direction of travel |
| 300 | second traffic situation |

1-11. (canceled)

12. A device for determining a suitable reference speed for at least one driver assistance system of a vehicle, comprising:
at least one surroundings detection unit configured to detect, in a current driving section, at least one item of surroundings information relating to surroundings of the vehicle at least over a region in front of the vehicle in a direction of travel of the vehicle and to generate surroundings data corresponding to the surroundings information, and
a processor configured to process the surroundings data and to determine a suitable reference speed for the current driving section based on the surroundings data.

13. The device according to claim 12, wherein the region in front of the vehicle detected by the surroundings detection unit is part of the current driving section, and/or wherein the current driving section is part of the region in front of the vehicle detected by the surroundings detection unit.

14. The device according to claim 12, wherein the current driving section is a route from the vehicle to a next traffic network node in the direction of travel.

15. The device according to claim 12, wherein the processor is configured to preset the determined reference speed and then as the maximum speed of the vehicle for the current driving section if lower than a permissible maximum speed.

16. The device according to claim 12, wherein the processor is configured to determine, based on the surroundings data, a traffic space available for the vehicle and the suitable reference speed.

17. The device according to claim 12, wherein the processor is configured to:
determine an available traffic space based on determining the driving envelope available for the vehicle in the current driving section;
perform an evaluation of the driving envelope; and
based on the evaluation of the driving envelope, determine the suitable reference speed.

18. The device according to claim 17, wherein the processor is configured to account for one or more environmental factors in the current driving section based on the surroundings data for evaluating the driving envelope, wherein a driving lane on which the vehicle is located is a driving lane of a road.

19. The device according to claim 18, wherein the one or more environmental factors comprises at least one of:
a width of the driving lane on which the vehicle is located,
a width of the vehicle,
a number of driving lanes in the direction of travel of the vehicle and/or in an opposite direction of travel,
a presence of a stationary vehicle on a right-hand side of the road,
a presence of a stationary vehicle on a left-hand side of the road,
a distance between a plurality of vehicles parked one behind the other on the right-hand side of the road,
a distance between a plurality of vehicles parked one behind the other on the left-hand side of the road,
a person in the driving lane,
a presence of a footpath and/or cycle path adjoining the driving lane,
a presence of a person and/or a vehicle in a footpath and/or cycle path adjoining the driving lane,
a classification of the road as a road within a closed area or outside a closed area,
a classification of the road as an expressway, secondary road and/or residential street,
a classification of the road as a road in a residential area or a commercial area or a non-built up area,
a width of the driving lane of the opposite direction of travel adjacent to the lane on which the vehicle is located,
a presence of an oncoming vehicle,
a width of an oncoming vehicle,
a possible and/or probable lateral distance from an oncoming vehicle when driving past one another,
a possible and/or probable lateral distance from a parked vehicle when driving past,
an obstacle present on the lane of the vehicle or on a lane adjacent to the lane,
a lateral narrowing of the driving lane,
currently existing vision,
a brightness of the surroundings of the vehicle and/or an illumination of the road, and/or
a time of day.

20. The device according to claim 18, wherein the processor is further configured to:
preset, for the one or more environmental factors, one or more speed values or factors increasing or reducing the reference speed, wherein:
in response to two or more speed values or factors being determined, the reference speed is preset based on a weighted mean value.

21. The device according to claim 19, wherein at least one suitable reference speed for the vehicle in the current driving section and one or more of the environmental factors associated with each of the at least one suitable reference speed are stored in a database arranged in the vehicle or in a database of the device arranged outside the vehicle as a reference speed to be preset.

22. The device according to claim 12, wherein the processor is configured to determine the suitable reference speed based on not exceeding a preset upper speed limit value and not falling below a preset lower speed limit value, wherein the preset upper speed limit value and the preset lower speed limit value are set based on a maximum speed permissible in the current driving section, wherein the upper speed limit value corresponds to the maximum speed permissible in the current driving section plus an offset that is set by or for a driver of the vehicle.

23. A method for determining a suitable reference speed for at least one driver assistance system of a vehicle, comprising:
detecting at least one piece of surroundings information relating to the surroundings of the vehicle at least over a region in a direction of travel of the vehicle in front of the vehicle in a current driving section by at least one surroundings detection unit, and surroundings data corresponding to the surroundings information is generated,
processing the surroundings data, and
determining a suitable reference speed for the current driving section based on the surroundings data.

24. The method according to claim 23, wherein the region in front of the vehicle detected by the surroundings detection unit is part of the current driving section, and/or wherein the current driving section is part of the region in front of the vehicle detected by the surroundings detection unit.

25. The method according to claim 23, wherein the current driving section is a route from the vehicle to a next traffic network node in the direction of travel.

26. The method according to claim 23, further comprising presetting the determined reference speed and the maximum speed of the vehicle for the current driving section if lower than a permissible maximum speed.

27. The method according to claim 23, further comprising determining, based on the surroundings data, a traffic space available for the vehicle and the suitable reference speed.

28. The method according to claim 23, further comprising:
determining an available traffic space based on determining a driving envelope available for the vehicle in the current driving section;
performing an evaluation of the driving envelope; and
determining the suitable reference speed based on the evaluation of the driving envelope.

29. The method according to claim 28, further comprising:
accounting for one or more environmental factors in the current driving section based on the surroundings data for evaluating the driving envelope, wherein a driving lane on which the vehicle is located is a driving lane of a road.

30. The method according to claim 29, wherein the one or more environmental factors comprises at least one of:
a width of the driving lane on which the vehicle is located,
a width of the vehicle,
a number of driving lanes in the direction of travel of the vehicle and/or in an opposite direction of travel,
a presence of a stationary vehicle on a right-hand side of the road,
a presence of a stationary vehicle on a left-hand side of the road,
a distance between a plurality of vehicles parked one behind the other on the right-hand side of the road,
a distance between a plurality of vehicles parked one behind the other on the left-hand side of the road,
a person in the driving lane,
a presence of a footpath and/or cycle path adjoining the driving lane,
a presence of a person and/or a vehicle in a footpath and/or cycle path adjoining the driving lane,
a classification of the road as a road within a closed area or outside a closed area,
a classification of the road as an expressway, secondary road and/or residential street,
a classification of the road as a road in a residential area or a commercial area or a non-built up area,
a width of the driving lane of the opposite direction of travel adjacent to the lane on which the vehicle is located,
a presence of an oncoming vehicle,
a width of an oncoming vehicle,
a possible and/or probable lateral distance from an oncoming vehicle when driving past one another,
a possible and/or probable lateral distance from a parked vehicle when driving past,
an obstacle present on the lane of the vehicle or on a lane adjacent to the lane,
a lateral narrowing of the driving lane, in particular for traffic calming, currently existing vision,
a brightness of the surroundings of the vehicle and/or an illumination of the road, and/or
a time of day.

31. The method according to claim 29, further comprising:
presetting, for the one or more environmental factors, one or more speed values or factors increasing or reducing the reference speed, wherein:
in response to two or more speed values or factors being determined, the reference speed is preset based on a weighted mean value.
